(19) United States
(12) Patent Application Publication
(10) Pub. No.: US 2009/0045640 A1
(43) Pub. Date: Feb. 19, 2009

(54) Multi-purpose earth tool

(76) Inventor: Rudy M. Trinidad, SR., Tucson, AZ (US)

Correspondence Address: Arian M. Wimer, 4990 W. Camino de Manana, Tucson, AZ, 85742, US

(21) Appl. No.: 11/894,021

(22) Filed: Aug. 17, 2007

(51) Int. Cl. A01B 1/22

(52) U.S. Cl. 294/51

(57) ABSTRACT

A multipurpose earth tool that allows a person to perform a variety of tasks on outdoor vegetation with ease and minimal effort and without the need to change tools to perform a variety of tasks. The multipurpose earth tool includes a handle, a head, a fastening system, and at least one interchangeable tool. The fastening system of the multipurpose earth tool can withstand extreme force and use without breaking, cracking, of splintering. The multipurpose earth tool is easy to store in a variety of positions. The multipurpose earth tool includes a releasable interchangeable tool that a person can remove and replace with optional tools.

### FIELD OF THE INVENTION

The present invention is directed to a multipurpose earth tool that includes a handle, a head, a fastening system, and at least one interchangeable tool to enable a person to perform a variety of tasks on outdoor vegetation with ease and minimal effort.

### BACKGROUND OF THE INVENTION

Persons using a hand tool to garden, excavate, maintain outdoor vegetation, and the like, often wish to perform such tasks with ease and minimal effort. They also may wish to have the ability to perform multiple tasks using a single hand tool without having to use multiple tools. Further, a person may wish to have a single hand tool that is able to withstand extreme use and force without breaking, cracking, or becoming unusable. Additionally, they may wish to have a single hand tool that is easy to store in more than one manner. However, most persons who wish to perform tasks, such as gardening, excavating, maintaining outdoor vegetation, and the like, must often bend over to perform such tasks or use a great amount of energy and repetitions to perform such tasks. Also, a person who wishes to perform tasks, such as gardening, excavating, maintaining outdoor vegetation, and the like, must either use several different hand tools to complete the tasks or use a single device. However, one problem with any single device tool that currently exists is a person must take the time to attach and detach different tool attachments. A problem with the current multi-purpose hand tools that exist are the inability to perform tasks, such as gardening, excavating, maintaining outdoor vegetation, and the like, effectively because of an imbalance of the garden tool and the weight of the garden tool. Another problem with current multi-purpose hand tools is the inability to withstand extreme force and use without breaking or cracking. Finally, current multi-purpose hand tools create damage to surrounding ground, plants, and vegetation and cause unnecessary damage.

Therefore, there is a need for a multi-purpose tool, where a person may perform tasks, such as gardening, excavating, maintaining vegetation, and the like, with ease, minimal effort, and one single tool.

### SUMMARY OF THE INVENTION

The present invention provides a multipurpose earth tool comprising a head, a first tool device, a second tool device, and a third tool device; a handle attached to the head; a fastening system mounted to the handle including a first stabilizer cap, a second stabilizer cap, a sleeve, and an attachment means; and an interchangeable tool attached to the handle.

The present invention provides a fastening system mounted to a handle including a first stabilizer cap, a second stabilizer cap, a sleeve, and an attachment means.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is a front perspective view of the multipurpose earth tool according to the invention.

FIG. 2 is a bottom view of the head shown in FIG. 1.

FIG. 3 is an exploded partial side view of the multipurpose earth tool including the fastening system according to the invention shown in FIG. 1.

FIG. 4A is a front view of the interchangeable tool shown in FIG. 1.

FIG. 4B is a front view of another embodiment of the interchangeable tool shown in FIG. 1.

FIG. 4C is a front view of another embodiment of the interchangeable tool shown in FIG. 1.

FIG. 4D is a front view of another embodiment of the interchangeable tool shown in FIG. 1.

FIG. 4E is a front view of another embodiment of the interchangeable tool shown in FIG. 1.

FIG. 4F is a front view of another embodiment of the interchangeable tool shown in FIG. 1.

FIG. 4G is a front view of another embodiment of the interchangeable tool shown in FIG. 1.

FIG. 4H is a front view of another embodiment of the interchangeable tool shown in FIG. 1.

FIG. 4I is a front view of another embodiment of the interchangeable tool shown in FIG. 1.

### DESCRIPTION OF PREFERRED EMBODIMENTS

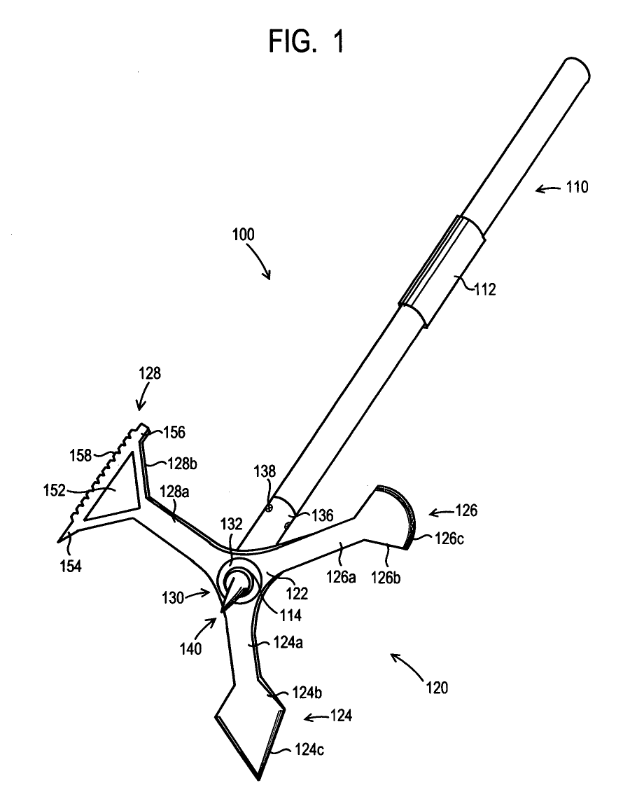

Referring now to FIG. 1, multipurpose earth tool 100 comprises handle 110, head 120, fastening system 130, and interchangeable tool 140. In the illustrated embodiment of FIG. 1, handle 110 comprises grip 112 and threaded housing 114. In the illustrated embodiment of FIG. 1, head 120 comprises central member 122, first tool device 124, second tool device 126, and third tool device 128. In the illustrated embodiment of FIG. 1, first tool device 124 comprises first elongated neck member 124a, first tool head 124b, and first sharp outer edge 124c. In the illustrated embodiment of FIG. 1, second tool device 126 comprises second elongated neck member 126a, second tool head 126b, and second sharp outer edge 126c. In the illustrated embodiment of FIG. 1, third tool device 128 comprises third elongated neck member 128a and third tool head 128b. In the illustrated embodiment of FIG. 1, third tool head 128b comprises aperture 152, pointed member 154, rectangular member 156, and teeth 158.

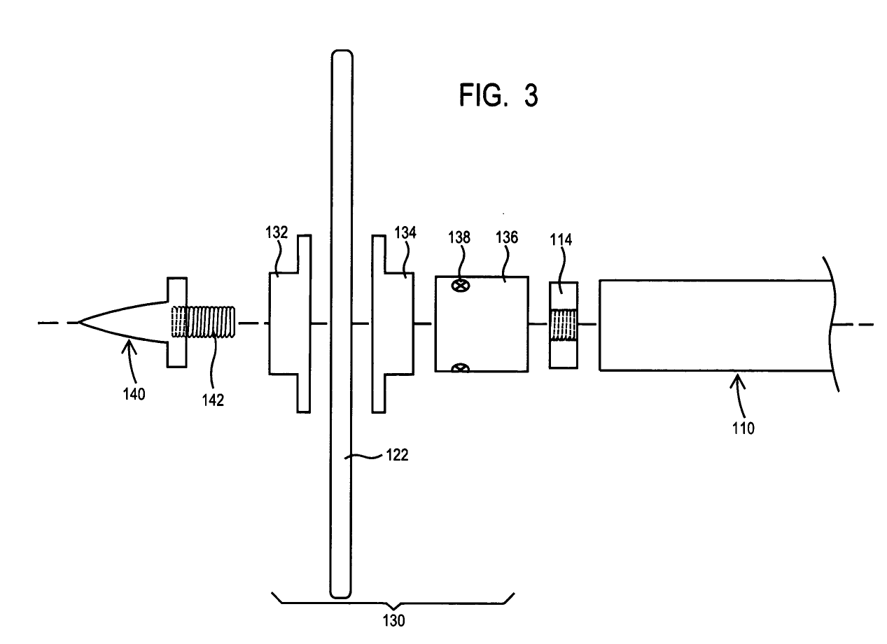

In the illustrated embodiment of FIG. 1, fastening system 130 comprises first stabilizer cap 132, sleeve 136, and attachment means 138. In certain embodiments, fastening system 130 comprises second stabilizer cap 134 (see FIG. 3). In the illustrated embodiment of FIG. 1, threaded housing 114 is inserted into a first end of handle 110 so that the bottom edge of threaded housing 114 is flush with the bottom edge of handle 110. In the illustrated embodiment of FIG. 1, threaded housing 114 is permanently attached to the inner surface of handle 110 by conventional attachment means, such as welding, screws, or the like. Fastening system 130 allows multipurpose earth tool 100 to function in intense environments where a person may apply an extreme force to multipurpose earth tool 100 without breaking, splintering, cracking, or the like.

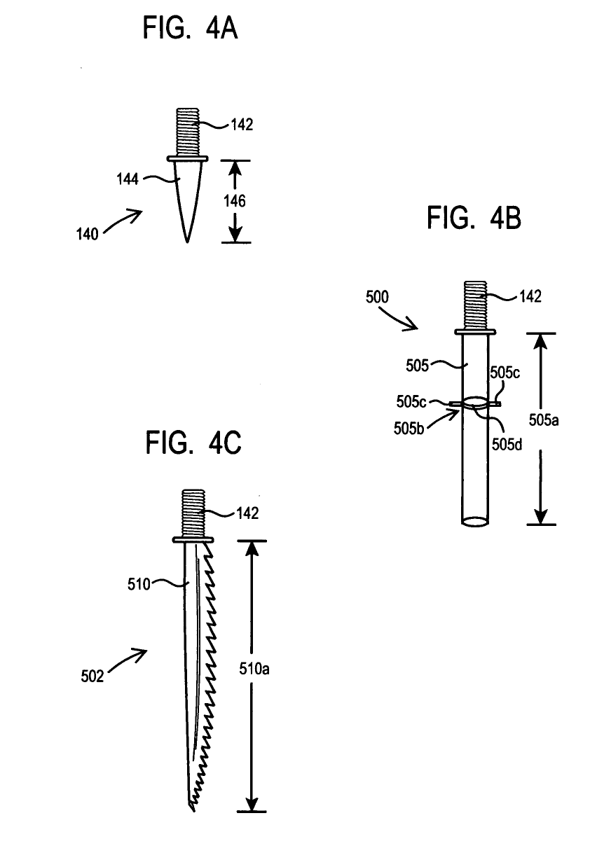

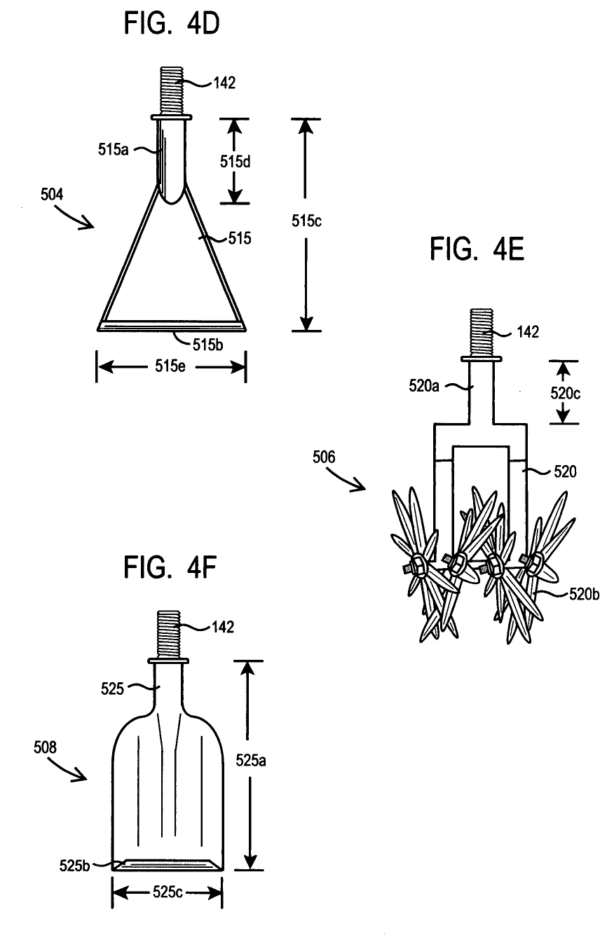

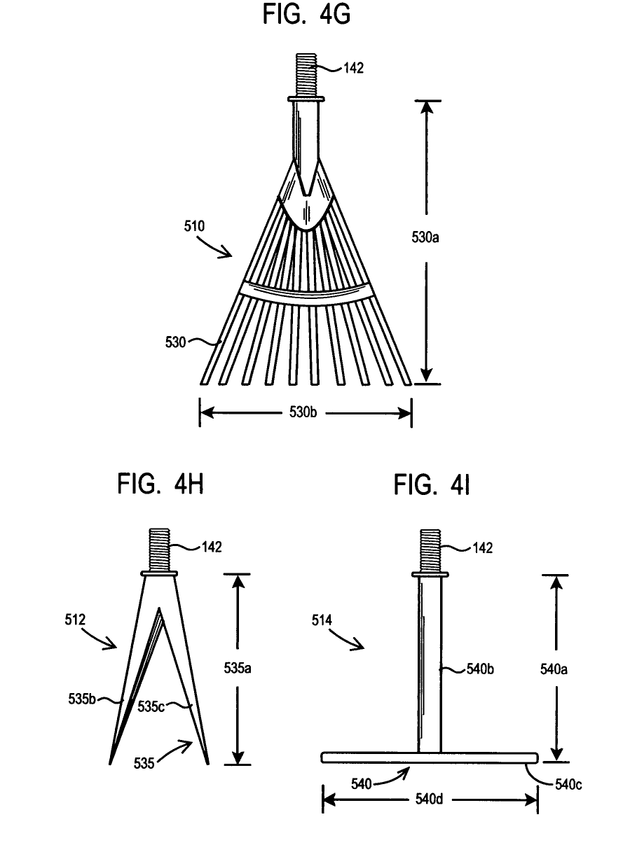

A person may easily rotate multipurpose earth tool 100 with a twist of handle 110 to have easy access to first tool device 124, second tool device 126, and third tool device 128 to perform a desired function simultaneously. A person may remove interchangeable tool 140 and replace it with any one of the below described embodiments of interchangeable tool 140 (see FIGS. 4A, 4B, 4C, 4D, 4E, 4F, 4G, 4H, and 41). A person may store multipurpose earth tool 100 easily by hanging multipurpose earth tool 100 upside-down on a flat surface so that first tool device 124, second tool device 126, or third tool device 128 of multipurpose earth tool 100 is in contact with the flat surface. Additionally, a person may idle multipurpose earth tool 100 by positioning multipurpose earth tool 100 horizontally on a flat dirt surface so that first tool device 124, second tool device 126, and third tool device 128 of multipurpose earth tool 100 is in contact with the flat dirt surface, thereby never needing to bend down to retrieve multipurpose earth tool 100 and always maintaining visibility of multipurpose earth tool 100.

In the illustrated embodiment of FIG. 1, central member 122, first tool device 124, second tool device 126, third tool device 128, first elongated neck member 124a, second elongated neck member 126a, and third elongated neck member 128a are formed together to form one head 120. In certain embodiments, first stabilizer cap 132 comprises a flanged tubular member. In certain embodiments, first stabilizer cap 132 comprises a flanged tubular member having a length between about % inch and about % inch. In certain embodiments, second stabilizer cap 134 comprises a flanged tubular member. In certain embodiments, second stabilizer cap 134 comprises a flanged tubular member having a length between about % inch and about % inch. In certain embodiments, attachment means 138 comprises conventional attachment means, such as welding, screws, or the like.

In certain embodiments, handle 110 comprises a rigid material selected from the group consisting of metal, an engineering plastic, wood, or combinations thereof. By “engineering plastic,” Applicant means a polymeric material comprising a tensile modulus of about 500,000 psi or greater, and/or a flexural modulus of about 500,000 psi or greater. Such polymeric materials include, without limitation, one or more polyamides, one or more polyimides, one or more polyetheretherketones, one or more cured epoxy resins, and the like. In certain embodiments, handle 110 comprises a tubular member with an outside diameter between about 1½ inches and about 3½ inches. In certain embodiments, handle 110 comprises a tubular member having a length between about 17 inches and about 60 inches. In certain embodiments, handle 110 comprises a solid member having a circular cross-section.

In certain embodiments, central member 122 comprises a rigid material selected from the group consisting of metal, an engineering plastic, wood, or combinations thereof. In certain embodiments, central member 122 comprises a three-pronged member having a thickness between about 2/16th inch and about 6/16th inch. In certain embodiments, central member 122 comprises a three-pronged member having each prong separated by 120 degrees.

In certain embodiments, first tool device 124 comprises a rigid material selected from the group consisting of metal, an engineering plastic, wood, or combinations thereof. In certain embodiments, first tool head 124b comprises a diamond-shaped hoe known to one skilled in the art. In certain embodiments, first tool device 124 comprises a sharp outer edge 124c on the outer two sides of the diamond-shaped hoe to allow the user to cut grass, vegetation, trenches, furrows, or the like.

In certain embodiments, second tool device 126 comprises a rigid material selected from the group consisting of metal, an engineering plastic, wood, or combinations thereof. In certain embodiments, second tool head 126b comprises an arched-shaped ax known to one skilled in the art. In certain embodiments, second tool device 126 comprises a sharp outer edge 126c on the outer arch of the ax to allow the user to cut grass, wood, vines, or the like.

In certain embodiments, third tool device 128 comprises a rigid material selected from the group consisting of metal, an engineering plastic, wood, or combinations thereof. In certain embodiments, third tool head 128b comprises an isosceles triangle-shaped member having at least two sides of equal length with each side having a length between about 2 inches and about 5 inches. In certain embodiments, third tool head 128b comprises teeth 158 formed on the outer edge of the isosceles triangle-shaped member. In certain embodiments, teeth 158 comprise flat-surfaced teeth members. In other embodiments, teeth 158 comprise pointed teeth members. In certain embodiments, third tool head 128b comprises aperture 152 within the body of the isosceles triangle-shaped member. Aperture 152 within third tool head 128b allows sifting, distributing, and the like of dirt when the user pushes or pulls third tool device 128 along the ground. Additionally, aperture 152 allows for securing large rocks and objects for removing, relocating, and the like. In certain embodiments, third tool head 128b comprises pointed member 154 on a first corner of third tool head 128b. In certain embodiments, third tool head 128b comprises rectangular member 156 on a second and opposite corner of third tool head 128b. Pointed member 154 allows the user to reach small crevices, corners, or hard-to-reach areas when working with multipurpose earth tool 100. Rectangular member 156 allows the user to scrape against flat concrete surfaces, curbs, and the like.

In certain embodiments, first elongated neck member 124a comprises a rigid material selected from the group consisting of metal, an engineering plastic, wood, or combinations thereof. In certain embodiments, first elongated neck member 124a comprises a solid member with a planar surface. In certain embodiments, first elongated neck member 124a comprises a length between about 1 inch and about 4 inches. In certain embodiments, first elongated neck member 124a comprises a thickness between about 2/16^{th} inch and about 6/16^{th} inch.

In certain embodiments, second elongated neck member 126a comprises a rigid material selected from the group consisting of metal, an engineering plastic, wood, or combinations thereof. In certain embodiments, second elongated neck member 126a comprises a solid member with a planar surface. In certain embodiments, second elongated neck member 126a comprises a length between about 1 inch and about 4 inches. In certain embodiments, second elongated neck member 126a comprises a thickness between about 2/16^{th} inch and about 6/16^{th} inch.

In certain embodiments, third elongated neck member 128a comprises a rigid material selected from the group consisting of metal, an engineering plastic, wood, or combinations thereof. In certain embodiments, third elongated neck member 128a comprises a solid member with a planar surface. In certain embodiments, third elongated neck member 128a comprises a length between about 1 inch and about 4 inches. In certain embodiments, third elongated neck member 128a comprises a thickness between about 2/16^{th} inch and about 6/16^{th} inch.

In certain embodiments, interchangeable tool 140 comprises a rigid material selected from the group consisting of metal, an engineering plastic, wood, or combinations thereof. In certain embodiments, interchangeable tool 140 comprises a solid member with a circular cross-section that decreases in diameter until it forms a spike. In certain embodiments, interchangeable tool 140 comprises a threaded solid top member that allows interchangeable tool 140 to be attached to threaded housing 114 by turning interchangeable tool 140 in a first direction. A person may remove interchangeable tool 140 from multipurpose earth tool 100 by turning interchangeable tool 140 in a second and opposite direction. In certain embodiments, interchangeable tool 140 comprises a solid member having a length between about ½ inch and about 1½ inches. In other embodiments, interchangeable tool 140 comprises a variety of shapes and sizes described hereinafter (see FIGS. 4B, 4C, 4D, 4E, 4F, 4G, 4H, and 4I).

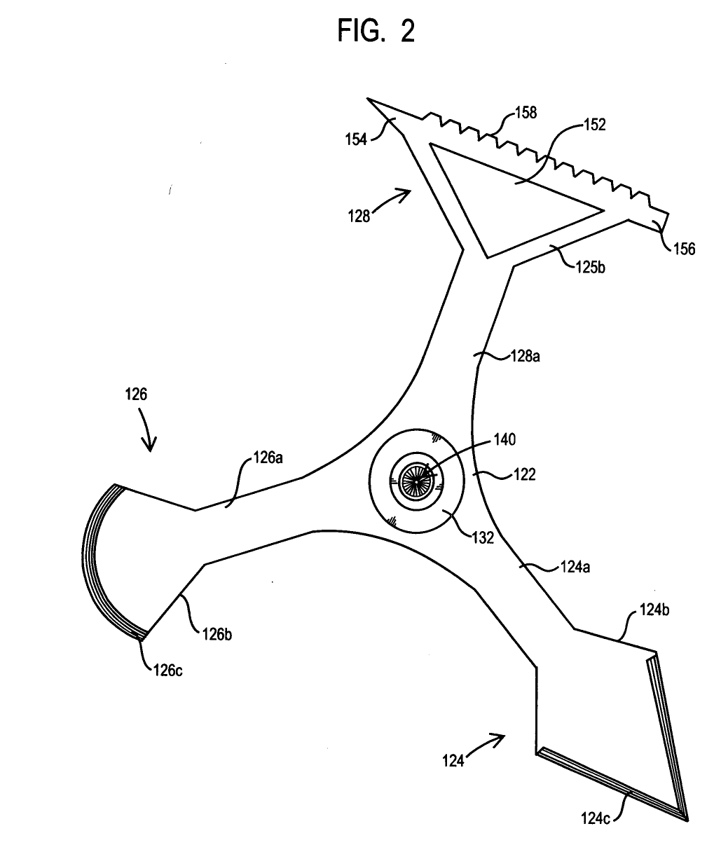

Referring now to FIG. 2, a bottom view of multipurpose earth tool 100 is shown comprising first tool device 124, second tool device 126, third tool device 128, first stabilizer cap 132, and interchangeable tool 140. In the illustrated embodiment of FIG. 2, first tool device 124, second tool device 126, and third tool device 128 are distributed around central member 122 in an equal distribution of 120 degrees. By “equal distribution,” Applicant means 120 degrees±2 degrees. When first tool device 124, second tool device 126, and third tool device 128 are separated by 120 degrees, multipurpose earth tool 100 provides the user with superior angles, is balanced, and provides object clearance when a person is using multipurpose earth tool 100 for gardening, excavating earth, clearing rocks and dirt, and the like.

Referring to FIG. 3, multipurpose earth tool 100 is shown in an exploded side view comprising handle 110, central member 122, fastening system 130, and interchangeable tool 140. In the illustrated embodiment of FIG. 3, fastening system 130 is shown in an exploded view. In the illustrated embodiment of FIG. 3, fastening system 130 comprises first stabilizer cap 132, second stabilizer cap 134, sleeve 136, and attachment means 138. In the illustrated embodiment of FIG. 3, first stabilizer cap 132 is placed on the bottom of head 120 at the most central portion of the head. In the illustrated embodiment of FIG. 3, second stabilizer cap 134 is place on the top of head 120 at the most central portion of the head. Sleeve 136 is placed over handle 110 so that the bottom edge of sleeve 136 is flush with the bottom edge of handle 110. Sleeve 136 and handle 110 are inserted through second stabilizer cap 134, head 120, and first stabilizer cap 132 until the bottom edge of handle 110 is flush with the outer most edge of first stabilizer cap 132. In the illustrated embodiment of FIG. 3, sleeve 136 is attached to handle 110 by attachment means 138. In the illustrated embodiment of FIG. 3, attachment means 138 comprises conventional attachment means, such as welding, screws, or the like. In the illustrated embodiment of FIG. 3, first stabilizer cap 132 and second stabilizer cap 134 are attached to head 120 by conventional attachment means, such as welding, screws, or the like. Multipurpose earth tool 100 can withstand a large amount of force without breaking, splintering, cracking, or the like due to the force that is applied by a person to multipurpose earth tool 100 being absorbed and distributed along sleeve 136 and handle 110 instead of having the full force on head 120 being absorbed and centered at the adjoining seam of head 120 and handle 110.

In the illustrated embodiment of FIG. 3, threaded housing 114 is inserted into a first end of handle 110 so that the bottom edge of threaded housing 114 is flush with the bottom edge of handle 110. In the illustrated embodiment of FIG. 3, threaded housing 114 is permanently attached to the inner surface of handle 110 by conventional attachment means, such as welding, screws, or the like. A person using multipurpose earth tool 100 may remove interchangeable tool 140 as described above (see FIGS. 1, 2, and 4A). The person may then insert a variety of other embodiments of interchangeable tool 140 (see FIGS. 4B, 4C, 4D, 4E, 4F, 4G, 4H, and 4I).

Referring to FIG. 4A, interchangeable tool 140 comprises threaded member 142 and spike 144. In certain embodiments, interchangeable tool 140 comprises a threaded member 142 that allows interchangeable tool 140 to be attached to threaded housing 114 by turning interchangeable tool 140 in a first direction as described above (see FIG. 3). A person may remove interchangeable tool 140 from multipurpose earth tool 100 by turning interchangeable tool 140 in a second and opposite direction, as described above. In certain embodiments, interchangeable tool 140 comprises a length 146 between about ½ inch and about 1½ inch.

Referring now to FIG. 4B, interchangeable tool 500 comprises threaded member 142 and corer member 505. In certain embodiments, interchangeable tool 500 comprises a threaded member 142 that allows interchangeable tool 500 to be attached to threaded housing 114 by turning interchangeable tool 500 in a first direction. A person may remove interchangeable tool 500 from multipurpose earth tool 100 by turning interchangeable tool 500 in a second and opposite direction. In certain embodiments, corer member 505 comprises a rigid material selected from the group consisting of metal, an engineering plastic, plastic, or combinations thereof. In certain embodiments, corer member 505 comprises a tubular member having an outside diameter between about 2 inches and about 4 inches. In certain embodiments, corer member 505 comprises a tubular member having a length 505a between about 2 inches and about 4 inches. In certain embodiments, corer member 505 comprises lever system 505b housed within corer member 505. In certain embodiments, lever system 505b comprises a first lever and second lever 505c and a planar surface member 505d which allows a person to push earth out of corer member 505 after a person has separated a core portion of the earth. When a person pushes on first lever and second lever 505c, planar surface member 505d is moved in a downward direction to push the earth out of corer member 505. In certain embodiments, first lever and second lever 505c can move upward in a first direction and downward in a second and opposite direction along a first vertical opening and a second vertical opening, respectively. In certain embodiments, first vertical opening and second vertical opening are on opposite sides of corer member 505 and extend from between about 2 mm and about 4 mm from the bottom of corer member 505 upward to the upper edge of corer member 505. In certain embodiments, lever system 505b comprises one lever 505c. In other embodiments, lever system 505b comprises more than one lever 505c. In other embodiments, lever system 505b comprises a spring-loaded mechanism including a push lever that allows a person to push earth out of corer member 505 after a person has separated a core portion of the earth. When interchangeable tool 500 is attached to multipurpose earth tool 100, a person may apply a downward force to multipurpose earth tool 100 such that corer member 505 will move downward through the earth and separate a core portion of the earth. The person can pull the multipurpose earth tool 100 upwardly and the cored portion of the earth can be removed using lever system 505b as described above.

Referring now to FIG. 4C, interchangeable tool 502 comprises threaded member 142 and saw blade 510. In certain embodiments, interchangeable tool 502 comprises a threaded member 142 that allows interchangeable tool 502 to be attached to threaded housing 114 by turning interchangeable tool 502 in a first direction. A person may remove interchangeable tool 502 from multipurpose earth tool 100 by turning interchangeable tool 502 in a second and opposite direction. In certain embodiments, saw blade 510 comprises a rigid material selected from the group consisting of metal, an engineering plastic, plastic, or combinations thereof. In certain embodiments, saw blade 510 comprises a standard saw blade known to one skilled in the art. In certain embodiments, saw blade 510 comprises a length 510a between about 3 inches and about 8 inches. In certain embodiments, saw blade 510 comprises teeth on the outer edge of saw blade 510. When interchangeable tool 502 is attached to multipurpose earth tool 100, a person may move multipurpose earth tool 100 in a first direction and in a second and opposite direction applying contact between saw blade 510 and an object to cut through the object or cut the object in pieces.

Referring now to FIG. 4D, interchangeable tool 504 comprises threaded member 142 and scraper 515. In certain embodiments, interchangeable tool 504 comprises a threaded member 142 that allows interchangeable tool 504 to be attached to threaded housing 114 by turning interchangeable tool 504 in a first direction. A person may remove interchangeable tool 504 from multipurpose earth tool 100 by turning interchangeable tool 504 in a second and opposite direction. In certain embodiments, scraper 515 comprises a rigid material selected from the group consisting of metal, an engineering plastic, plastic, or combinations thereof. In certain embodiments, scraper 515 comprises a standard scraper known to one skilled in the art. In certain embodiments, scraper 515 comprises a scraper attached to a neck member 515a having a length 515d between about 1 inch and about 2 inches. In certain embodiments, interchangeable tool 504 comprises a length 515c between about 2 inches and about 4 inches. In certain embodiments, outer edge 515b comprises a length 515e between about 1 inch and about 3 inches. In certain embodiments, scraper 515 comprises a sharp outer edge 515b. When interchangeable tool 504 is attached to multipurpose earth tool 100, a person may use the edge 515b of scraper 515 to dig around objects on the ground, to scrape objects from the ground, to lift object off the ground, or tear down objects that are above the person's head.

Referring now to FIG. 4E, interchangeable tool 506 comprises threaded member 142 and cultivator member 520. In certain embodiments, interchangeable tool 506 comprises a threaded member 142 that allows interchangeable tool 506 to be attached to threaded housing 114 by turning interchangeable tool 506 in a first direction. A person may remove interchangeable tool 506 from multipurpose earth tool 100 by turning interchangeable tool 506 in a second and opposite direction. In certain embodiments, cultivator member 520 comprises a rigid material selected from the group consisting of metal, an engineering plastic, plastic, or combinations thereof. In certain embodiments, cultivator member 520 comprises a standard cultivator known to one skilled in the art. In certain embodiments, cultivator member 520 is attached to a neck member 520a having a length 520c between about 2 inches and about 4 inches. In certain embodiments, cultivator member 520 comprises a plurality of teeth 520b that rotate in a first direction and in a second and opposite direction to till the ground. When interchangeable tool 506 is attached to multipurpose earth tool 100, a person can move multipurpose earth tool 100 along the ground and the movement of the teeth along the ground will till and break up the ground.

Referring now to FIG. 4F, interchangeable tool 508 comprises threaded member 142 and shovel member 525. In certain embodiments, interchangeable tool 508 comprises a threaded member 142 that allows interchangeable tool 508 to be attached to threaded housing 114 by turning interchangeable tool 508 in a first direction. A person may remove interchangeable tool 508 from multipurpose earth tool 100 by turning interchangeable tool 508 in a second and opposite direction. In certain embodiments, shovel member 525 comprises a rigid material selected from the group consisting of metal, an engineering plastic, plastic, or combinations thereof. In certain embodiments, shovel member 525 comprises a standard shovel known to one skilled in the art. In certain embodiments, interchangeable tool 508 is comprises a length 525a between about 3 inches and about 6 inches. In certain embodiments, shovel member 525 comprises a sharp outer edge 525b. In certain embodiments, outer edge 525b comprises a length 525c between about 2 inches and about 3 inches. When interchangeable tool 508 is attached to multipurpose earth tool 100, a person can apply downward force to multipurpose tool 100 and shovel member 525 is forced into the ground. When the person pulls multipurpose earth tool 100 upward, shovel member 525 will contain part of the ground.

Referring now to FIG. 4G, interchangeable tool 510 comprises threaded member 142 and rake 530. In certain embodiments, interchangeable tool 510 comprises a threaded member 142 that allows interchangeable tool 510 to be attached to threaded housing 114 by turning interchangeable tool 510 in a first direction. A person may remove interchangeable tool 510 from multipurpose earth tool 100 by turning interchangeable tool 510 in a second and opposite direction. In certain embodiments, rake 530 comprises a rigid material selected from the group consisting of metal, an engineering plastic, plastic, or combinations thereof. In certain embodiments, rake 530 comprises a standard rake known to one skilled in the art. In certain embodiments, rake 530 comprises a length 530a between about 4 inches and about 8 inches. In certain embodiments, rake 530 comprises a plurality of teeth. In certain embodiments, the bottom edge of rake 530 comprises a length 530b between about 4 inches and about 5 inches. When interchangeable tool 510 is attached to multipurpose earth tool 100, a person can move multipurpose earth tool 100 along the ground and the movement of the teeth along the ground will pull objects on the ground upward and into a pile.

Referring now to FIG. 4H, interchangeable tool 512 comprises threaded member 142 and scissor blade member 535. In certain embodiments, interchangeable tool 512 comprises a threaded member 142 that allows interchangeable tool 512 to be attached to threaded housing 114 by turning interchangeable tool 512 in a first direction. A person may remove interchangeable tool 512 from multipurpose earth tool 100 by turning interchangeable tool 512 in a second and opposite direction. In certain embodiments, scissor blade member 535 comprises a rigid material selected from the group consisting of metal, an engineering plastic, plastic, or combinations thereof. In certain embodiments, scissor blade member 535 comprises a standard scissor known to one skilled in the art. In certain embodiments, interchangeable tool 512 comprises a length 535a between about 2 inches and about 4 inches. In certain embodiments, scissor blade member 535 comprises a first blade 535b and a second blade 535c. When interchangeable tool 512 is attached to multipurpose earth tool 100, a person may move multipurpose earth tool 100 in a first direction and in a second and opposite direction applying scissor blade member 535 to an object to cut through the object or cut the object in pieces.

Referring now to FIG. 4I, interchangeable tool 514 comprises threaded member 142 and tamper member 540. In certain embodiments, interchangeable tool 514 comprises a threaded member 142 that allows interchangeable tool 514 to be attached to threaded housing 114 by turning interchangeable tool 514 in a first direction. A person may remove interchangeable tool 514 from multipurpose earth tool 100 by turning interchangeable tool 514 in a second and opposite direction. In certain embodiments, tamper member 540 comprises a rigid material selected from the group consisting of metal, an engineering plastic, plastic, or combinations thereof. In certain embodiments, tamper member 540 comprises a standard tamper known to one skilled in the art. In certain embodiments, tamper member 540 comprises neck member 540b. In certain embodiments, neck member 540b comprises a length between about 2 inches and about 5 inches. In certain embodiments, tamper member 540 comprises a length 540a between about 3 inches and about 6 inches. In certain embodiments, tamper member 540 comprises a planar surface member 540c having a thickness between about ⅛^{th} inch and about ¼ inch. In certain embodiments, planar surface member 540c comprises a width 540d between about 4 inches and about 6 inches. When interchangeable tool 514 is attached to multipurpose earth tool 100, a person may move multipurpose earth tool 100 in a downward motion and the planar surface member 540c of tamper member 540 will flatten the ground.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

1. A multipurpose earth tool, comprising:
a head including a substantially planar central member, said substantially planar central member further including a first surface, a second surface, and an aperture, said head further including a first tool device, a second tool device, and a third tool device, said first tool device comprising a diamond-shaped hoe, said first tool device further including an elongated neck member, said diamond-shaped hoe including a sharpened outer edge, said second tool device comprising an axe, said second tool device further including an elongated neck member, said axe including a sharpened outer edge, said third tool device comprising an isosceles triangle-shaped member, including teeth formed on the outer edge of said isosceles triangle-shaped member, an aperture within the body of said isosceles triangle-shaped member, said aperture forming an isosceles triangle-shape, a pointed member formed on a first corner of said isosceles triangle-shaped member, and a rectangular member formed on a second and opposite corner of said isosceles triangle-shaped member, said third tool device further including an elongated neck member;
a handle attached to said head and oriented with respect to said head such that said handle is substantially perpendicular to said head, said handle further comprising a first end and a second end, said second end further comprising a cavity and a threaded housing, said threaded housing encased in said cavity;
a fastening system mounted to said handle including a first stabilizer cap, a second stabilizer cap, a sleeve, and an attachment means, said first stabilizer cap and said second stabilizer cap further including a flanged tubular member; and
an interchangeable tool attached to said handle and oriented with respect to said head such that said interchangeable tool is substantially perpendicular to said head.

2. The multipurpose earth tool of claim 1, wherein said handle further comprises a hand grip.

3-5. (canceled)

6. The multipurpose earth tool of claim 1, wherein said first tool device, said second tool device, and said third tool device have an equal horizontal separation of one hundred and twenty degrees.

7. The multipurpose earth tool of claim 1, wherein a bottom surface of said first stabilizer cap is mounted on said first surface of said substantially planar central member, a bottom surface of said second stabilizer cap is mounted on said second surface of said substantially planar central member, said handle is encased in said sleeve, wherein said sleeve is inserted and mounted inside said second stabilizer cap, said substantially planar central member, and said first stabilizer cap.

8. The multipurpose earth tool of claim 1, wherein said handle, said head, said fastening system, and said interchangeable tool further comprise a rigid material.

9. The multipurpose earth tool of claim 1, wherein said interchangeable tool is releasably attached to said threaded housing.

10. The multipurpose earth tool of claim 1, wherein said interchangeable tool further comprises a spike.

11. The multipurpose earth tool of claim 1, wherein said interchangeable tool further comprises a corer member.

12. The multipurpose earth tool of claim 1, wherein said interchangeable tool further comprises a saw blade.

13. The multipurpose earth tool of claim 1, wherein said interchangeable tool further comprises a scraper.

14. The multipurpose earth tool of claim 1, wherein said interchangeable tool further comprises a cultivator member.

15. The multipurpose earth tool of claim 1, wherein said interchangeable tool further comprises a shovel member.

16. The multipurpose earth tool of claim 1, wherein said interchangeable tool further comprises a rake.

17. The multipurpose earth tool of claim 1, wherein said interchangeable tool further comprises a scissor blade member.

18. The multipurpose earth tool of claim 1, wherein said interchangeable tool further comprises a tamper member.

19-20. (canceled)
